(19) United States
(12) Patent Application Publication
(10) Pub. No.: US 2015/0212862 A1
(43) Pub. Date: Jul. 30, 2015

(54) COMPILATION SYSTEM FOR EXECUTABLE OBJECTS

(71) Applicant: Gregory Stuart Snider, Los Altos, CA (US)

(72) Inventor: Gregory Stuart Snider, Los Altos, CA (US)

(21) Appl. No.: 14/417,224

(22) PCT Filed: Jul. 30, 2012
(86) PCT No.: PCT/US2012/048822

§ 371 Date: Jan. 26, 2015

(51) Int. Cl. G06F 9/52; G06F 9/48

(52) U.S. Cl. CPC G06F 9/52; G06F 9/4881

(57) ABSTRACT

In one implementation, a compilation system identifies a plurality of objects within a description of an application, determines a plurality of state paths among the objects, and generates a plurality of executable objects that are independently executable and are each associated with a data structure representing a state of that executable object. Each state path is derived from an operation included in the description of the application on an object from the objects for which another object from the objects is an operand. Each executable object includes instructions that when executed at a host cause the host to perform an operation associated with that executable object and provide the state of that executable object to one or more other executable objects from the plurality of executable objects according to one or more state paths in response to a synchronization mechanism not defined within the description of the application.

### BACKGROUND

Parallel computing is a computing methodology in which multiple calculations are performed simultaneously. For example, a computing system including a multi-core processor can perform a calculation on each core simultaneously to implement parallel computing. As a specific example, a graphics processing unit (GPU) can be provisioned or configured to perform multiple calculations simultaneously. As another example, a group of computing systems in communication one with another can cooperatively perform parallel computing by performing calculations simultaneously. Such groups of computing systems are often referred to as distributed computing systems or environments.

Parallel computing methodologies can significantly reduce the time required to perform computing tasks. However, properly programming applications for parallel processing to avoid race conditions, deadlocks, and logic errors can be difficult. Moreover, many parallel computing methodologies are non-deterministic, which complicates verification, replication, and debugging of applications and errors within such applications.

### BRIEF DESCRIPTION OF THE DRAWINGS

FIG. 1 is an illustration of a process flow including a compile on system, according to an implementation.

FIG. 2 is a schematic block diagram of compilation system according to art implementation.

FIG. 3 is a flowchart of a compilation process, according to an implementation.

FIG. 4 is an ion of description of an application, according to an implementation.

FIG. 5 is an illustration of a graph of executable objects and state paths among the executable objects, according to an implementation.

FIG. 6 is an illustration of an executable object generated at a compilation system, according to an implementation.

FIG. 7 is a flowchart of a process implemented by an executable object, according to an implementation.

FIG. 8 is a schematic block diagram of a compilation system hosted at a computing system, according to an implementation.

### DETAILED DESCRIPTION

Although a variety of programming methodologies and frameworks exist for implementing parallel computing, systems that realize or implement parallel computing are typically difficult to program and to verify. Common approaches to parallel computing include the use of simultaneously executing threads (or lightweight processes or even standard processes) that reference common semaphores or mutual exclusion (or murex) objects at programmatically-defined execution points to prevent simultaneous access to particular resources (e.g., memory or hardware devices); the Message Passing Interface (MPI); and actor programming models.

Parallel computing based on simultaneously executing threads is error-prone because programmers specify the execution points at which the threads are not allowed to execute simultaneously. Often, obscure programming errors can result in race conditions and deadlocks. Moreover, because the threads execute simultaneously most of the time, execution of an application (implemented by the threads) differs each time it runs due to non-deterministic thread scheduling, which complicates detection of un-time errors. Furthermore, run-time errors can be difficult to debug because the interaction of a debugger with the application alters the execution of the application, which can prevent errors such as race conditions and deadlocks from occurring during testing. Additionally, in distributed computing environments, a shared-memory infrastructure is often required to support a thread-based parallel computing methodology and can be difficult to scale for large applications.

MPI allows processes distributed across a communications link (e.g., a distributed computing environment) to communicate by exchanging messages. However, similar to the thread-based parallel computing methodology, MPI typically relies on independent, distributed processes to perform the parallel calculations. Because these processes execute independently, execution of an application (implemented by the processes) differs each time it runs due to non-deterministic scheduling of the processes, which can obscure run-time errors. Additionally, any data shared between processes and the mechanisms for sharing data is described or specified when the application is programmed. That is, application developers specify the message passing points of the application. As a result, obscure programming errors can be introduced by the application developers. Moreover, debugging applications that rely on MPI can be difficult because the interaction of a debugger with the application alters the execution of the application which can prevent errors such as race conditions and deadlocks from occurring during testing.

Similarly, an actor model typically relies on simultaneous, independent processes to perform simultaneous calculations. In the actor model, the processes (or actors) do not share memory. Although this feature of the actor model eliminates some, difficulties with the thread-based parallel computing discussed above, actors suffer from the same non-deterministic run-time and debugging characteristics of the thread-based parallel computing and MPI discussed above.

Implementations disclosed herein implement parallel computing methodologies that are deterministic at run-time, are repeatable, are scalable, and can readily be debugged. Moreover, application developers need not specify synchronization mechanisms (e.g., semaphores, mutex objects, or message passing points) when programming an application. Rather, for example, systems and methods discussed herein identify state paths (e.g., exchange of data or state between objects) within a description of an application and generate a group of executable objects that execute synchronously in parallel to implement the application by exchanging data according to state paths and performing operations on such data.

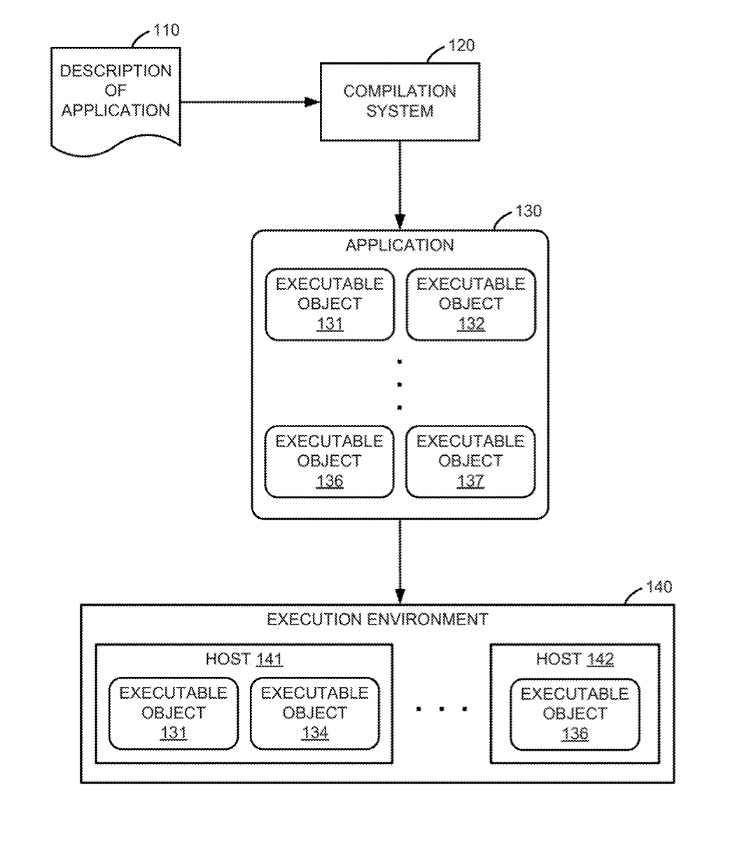

FIG. 1 is an illustration of a process flow including a compilation system, according to an implementation. Compilation system 120 accesses (e.g., reads or receives) description of application 110 and generates application 130 based on description of application 110. Application 130 is then executed or hosted at execution environment 140. Execution environment 140 includes hosts (e.g., hosts 141 and 142) at which executable objects of application 130 execute or are hosted. Hosts can be any combination of hardware and software at which executable objects can execute. For example, a host can be a virtual machine or logical processor, a processor such as a central processing unit (CPU) or GPU, a core or execution engine of a processor, or a computing system. Accordingly, execution environment 140 can be a computing system or a distributed computing environment such as a computer duster including a group of computing systems in communication one with another via a communications link. In some implementations, an execution environment can include a single host such as a GPU capable of executing multiple simultaneous execution threads. Moreover, the hosts of execution environment 140 can be homogenous or heterogeneous. As used herein, the phrase “host for an executable object” and similar phrases refer to a host at which one or more executable objects are or can be executed.

Description of application 110 describes or defines an application. Said differently, description of application 110 includes groups of symbols that describe or define operations and objects relative to which those operations are associated. Such operations and objects (and related instructions such as host-specific instructions to effect such operations and objects) are included within description of application 110. For example, description of application 110 can be a source code file or group of source code files including instructions in any of a variety of programming languages. As specific examples, description of application 110 can conform to any or multiple of the following programming languages: Scala, C, C++, Java™, Objective-C, and Python. In some implementations, description of application 110 can conform to a markup language such as Extensible Markup Language (XML). In some implementations, description of application 110 includes compiled components such as libraries or binary components.

Compilation system 120 analyzes description of application 110 to identify objects within description of application 110 and state paths among the objects. An object is an entity or construct that defines a state which is operated on within an application. For example, an object can be an instance of a class within an object-oriented programming language. As another example, an object can be a data structure that defines an arrangement of variables and/or objects that are the state of the object. More specifically, for example, an object can be a data structure that defines or describes an arrangement of variables, arrays of variables, multi-dimensional arrays of variables, objects, arrays of objects, and/or multi-dimensional arrays of objects at which the state of the object is stored. An object is operated on when the state of the object (e.g., values or data within variables or objects of the object) is altered or accessed.

A state path is a flow (or exchange) of state from one object to another object. A state path can be unidirectional (i.e., state flows from one object to another object), or bidirectional (i.e., state flows from a first object to a second object and from the second object to the first object). A state path can be identified in description of application 110 where the state of one object is used to modify the state of another object. In other words, state paths can be implicit in the interaction between objects, and compilation system 120 identifies such state paths. As an example, if a first object is the input to a function (i.e., an operand of an operation performed by the function) within description of application 110 and a result of the function is stored at a second object (i.e., the operation is performed on the second object), a flow path exists between the first object and the second object. Said differently, the state of the first object (together with one or more operations) is used to modify the second object.

Although the first object and the second object can be referred to as operands of operations performed by the function, when emphasizing that an object is altered by an operation, such an object is referred to herein as being operated on by the operation or as having the operation performed on that object. Similarly, the operation can be said to be an operation on that object. Moreover, references herein to objects as operands of an operation do not mean that the operation does not alter those objects (or a state thereof). Rather, such references to operands are meant to emphasize that the states of such objects are used by an operation on another object to alter the state of that other object.

Compilation system 120 analyzes the state paths and objects described or defined (either implicitly or explicitly) at description of application 110, and generates application 130. Application 130 includes a group of executable objects which synchronously and simultaneously execute operations included within (e.g., described or defined at) description of application 110. An executable object includes instructions for performing an operation (e.g., a single calculation or a group of related calculations) included within description of application 110, and a description of a data structure at which a state of the executable object can be stored, and can be stored at a processor-readable medium and executed at a host.

Such instructions can be said to be included within description of application 110 because these instructions are derived from operations and/or objects included within description of application 110. In other words, compilation system 120 generates such instructions based on symbols, syntax, and/or other elements of description of application 110 that define or describe the operations and objects included within description of application 110 and on information related to a host for an executable object or related to an intermediate representation language (or grammar). Thus, some instructions of an executable object are based on operations included within description of application 110 relative to one or more objects.

In addition to instructions derived from description of application 110, an executable object also includes instructions that are not included (or defined or described) within description of application 110. In other words, an executable object includes instructions that are not derived from operations or objects included within description of application 110. Such instructions are generated by compilation system 120 without reference to the operations or objects included within description of application 110, and can be, for example, for exchanging (i.e., providing to another executable object and/or receiving from another executable object) state in response to a synchronization mechanism that is also not included (or described or defined) at description of application 110. In other words, the synchronization mechanism is not referenced within description of application 110, and, therefore, not determined by the developer of the application described by description of application 110.

Said differently, description of application 110 does not include symbols, objects, or operations that implicitly or explicitly refer to the synchronization mechanism or the instructions to implement or respond to the synchronization mechanism. Such instructions are included in an executable object by compilation system 120 to provide synchronous, simultaneous execution of executable objects in application 130. In some implementations, compilation system 120 also generates instructions to provide a synchronization mechanism to executable objects that implement an application.

The data structure of an executable object corresponds to an object described or defined, at description of application 110. Said differently, the state of an executable object corresponds to the state of an object described or defined at description of application 110. Thus, an executable object can be referred to as corresponding to an object described or defined at description of application 110. In some implementations, executable objects of application 130 generated by compilation system 120 based on description of application 110 uniquely correspond to objects described or defined at description of application 110. In other word, a single executable object within application 130 corresponds to a single object described or defined at description of application 110.

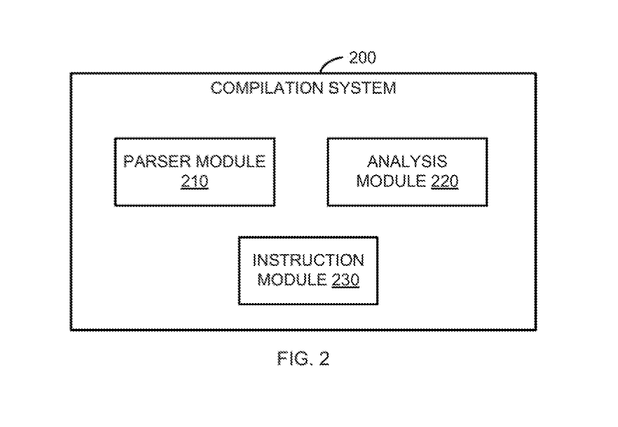

Compilation system 120 can include a variety of components (or modules) to generate application 130 based on description of application 110. For example, FIG. 2 is a schematic block diagram of compilation system, according to an implementation. Although various modules (i.e., combinations of hardware and software) are illustrated and discussed in relation to FIG. 2 and other example implementations, other combinations or sub-combinations of modules can be included within other implementations. Said differently, although the modules illustrated FIG. 2 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

Compilation system 200 includes parser module 210, analysis module 220, and instruction module 230. Parser module 210 is a combination of hardware and software that parses a description of an application to identify objects within the description of the application. For example, parser module 210 can interpret syntax, keywords, symbolic names, and other information included in the description of the application to identify objects described within the description of the application. As a specific example, parser module 210 performs lexical analysis, syntactic analysis, and semantic analysis to identify objects within the description of the application.

Analysis module 220 analyzes relationships among objects to determine state paths between the objects. For example, analysis module 220 analyzes operations described in the description of the application to determine whether state of objects are exchanged by the operations. As specific examples, analysis module 220 can identify objects that are the operands of an operation (e.g., operands of an arithmetic operation or arguments provided to a function or method call) and an object on which the operation is performed. Analysis module 220 can then determine that a state path exists from the objects that are the operands of an operation to the object on which the operation is performed. Said differently, analysis module 220 identifies how state flows among objects described in the description of the application.

Instruction module 230 generates executable objects based on objects and operations described in the description of the application and state paths determined at analysis module 220. For example, instruction module 230 can generate instructions to implement at a memory of a host a data structure that corresponds to a data structure of an object at which a state of the executable object can be stored. Said differently, instruction module 230 outputs groups of instructions that when executed at a host cause the host to implement an executable object that corresponds to an object.

Instruction module 230 generates for each executable object a group of instructions that correspond to an operation described in the description of the application. For example, the operation can be to modify the state of the executable object using calculations described in the description of the application (e.g., as a function or as an operator) and the state of other executable objects. Moreover, each executable object is executable individually or independently. That is, each executable object can be hosted or executed at a different host, and can perform an operation associated with that executable object without input or cooperation from other executable objects. Thus, each executable object can perform its operation independent of other executable objects. Moreover, an executable object that is independently executable can provide data to and/or receive data from another executable object between operations.

Operations discussed herein include operations that are not atomic at the hosts for the executable objects associated with those operations. For example, these operations include operations with multiple calculations, steps, or sub-operations. As a specific example, an operation can include a matrix manipulation including a number of addition, multiplication, and store steps, each of which is atomic at a the host for the executable object associated with that operation, but which are collectively non-atomic (e.g., the host can be interrupted between any two steps). Thus, en operation associated with en executable object can include multiple (e.g., tens, hundreds, or thousands) of individual steps that can be interrupted, delayed, or paused at the host executing the executable object associated with that operation.

In addition to instructions based on objects and operations described in the description of the application, instruction module 230 also generates instructions to cause executable objects (when executed at a host) to execute synchronously and to exchange state according to state paths determined by analysis module 220. More specifically, instruction module 230 generates instructions for each executable object that cause the executable object to respond to a synchronization mechanism. For example, instruction module 230 can include instructions in each executable object that cause the executable objects to wait for a synchronization signal from a synchronization mechanism after performing an operation derived from the description of the application. Additionally, the instructions can cause the executable objects to provide their state along state paths to other executable objects in response to the synchronization mechanism. After states are exchanged among executable objects, the executable objects again perform their respective operations using the newly received states. In some implementations, the instructions cause the executable objects to wait again for the synchronization signal from the synchronization mechanism before again performing their respective operations.

Such instructions causing the executable objects to wait or be responsive to a synchronization mechanism can simplify debugging of parallel computing applications. For example, a debugger can control or replace a synchronization mechanism to control the execution of the application. That is, the debugger can suppress a synchronization mechanism to prevent the executable objects (executing individually to implement the application) from continuing to execute. The debugger (or debugging system) can monitor (e.g., access data stored at memory) the execution of each executable object of the application while the executable objects are waiting for the synchronization mechanism, and provide or allow the synchronization mechanism to the executable objects after observing the executable objects to cause the executable object to continue to execute.

Additionally, such instructions cause parallel computing applications to have deterministic execution. For example, because the execution of the executable objects comprising the application are synchronized each time the executable objects complete their respective operation, the application has a common execution path each time it is executed. Such debugging support and determinism can simplify the development of parallel computing applications.

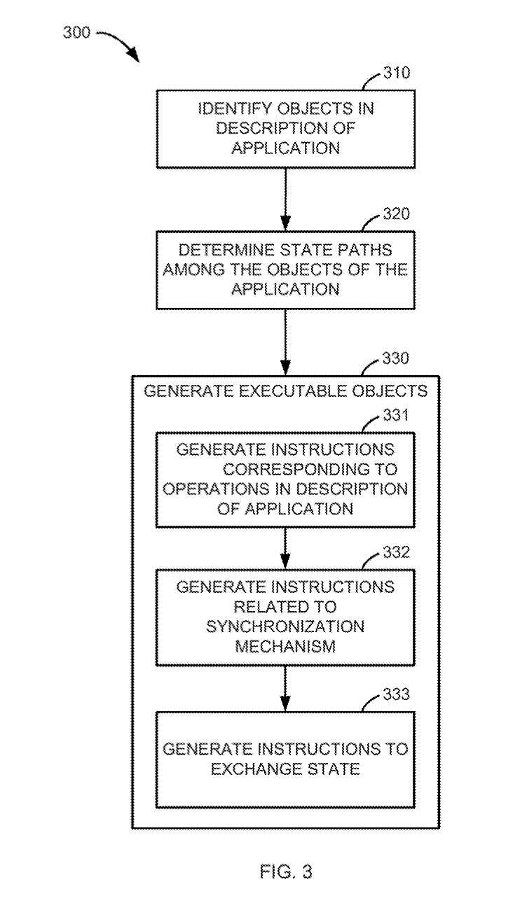

FIG. 3 is a flowchart of a compilation process, according to an implementation. Process 308 is an example implementation. In other implementations, steps or blocks can be rearranged and/or additional or fewer steps or blocks can be included in a compilation process according to various implementations. Process 300 illustrated at FIG. 3 can be implemented, for example, at a compilation system such as a compilation system hosted at a computing system. The compilation system identifies objects in a description of an application. For example, the compilation system can identify the objects based on keywords, variable names, syntax, or other information included within the description of the application.

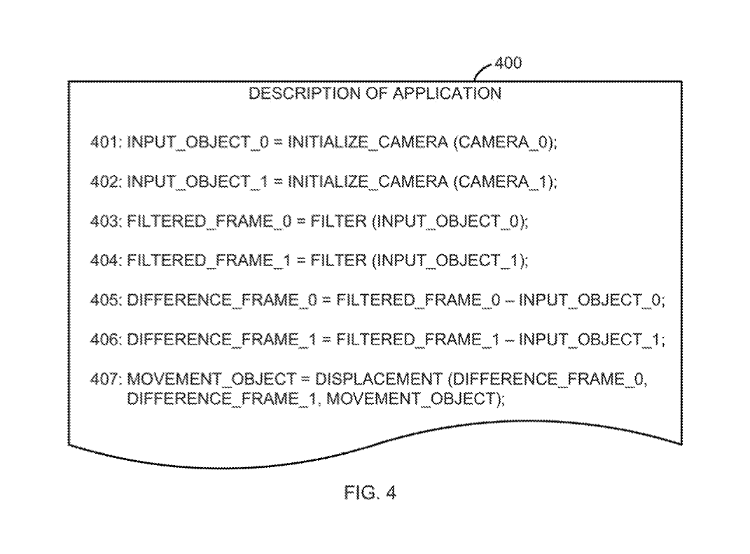

As a more specific example, FIG. 4 is an illustration of description of an application, according to an implementation. The application described by description of application 400 captures images from two cameras, applies filters to each image (e.g., to sharpen the images or remove artifacts from the images), determines a difference between a previously captured image and a current image for each camera, and determines movement characteristics of some feature of the images. INPUT_OBJECT_{—}0, INPUT_OBJECT_{—}1, FILTERED_FRAME_{—}0, FILTERED_FRAME_{—}1, DIFFERENCE_FRAME_{—}_{—}0, DIFFERENCE_FRAME1, and MOVEMENT_OBJECT are objects. Although not illustrated in FIG. 4, these objects can include explicit definitions of data structures associated with or included within these objects. For example, INPUT_OBJECT_{—}0, INPUT_OBJECT_{—}1, FILTERED_FRAME_{—}0, FILTERED_FRAME_{—}1, DIFFERENCE_FRAME_{—}0, and DIFFERENCE_FRAME_{—}1 can include a two-dimensional array at which pixel values of an image can be stored.

More specifically, INPUT_OBJECT_{—}0 is an object that defines an interface with a first camera identified as CAMERA_{—}0, and INPUT_OBJECT_{—}1 is an object that defines an interface with a second camera identified as CAMERA_{—}1. For example, images such as video frames captured by the first and second cameras can be accessed at INPUT_OBJECT_{—}0 and INPUT_OBJECT_{—}1, respectively. As illustrated in lines 401 and 402 of description of application 400, INPUT_OBJECT_{—}0 and INPUT_OBJECT_{—}1 are initialized relative to their respective cameras.

FILTERED_FRAME_{—}0 and FILTERED_FRAME_{—}1 are filtered versions of images accessed via INPUT_OBJECT_{—}0 and INPUT_OBJECT_{—}1. As illustrated in lines 403 and 404, INPUT_OBJECT_{—}0 and INPUT_OBJECT_{—}1 are provided as arguments to the FILTER( ) function, and the results are assigned to FILTERED_FRAME_{—}0 and FILTERED_FRAME_{—}1 respectively. For example, the FILTER( ) function can access a current image from INPUT_OBJECT_{—}0 and perform a filtering operation on the image. The resulting filtered image is stored at FILTERED_FRAME_{—}0. Similarly, a filtered image based on a current image from. INPUT_OBJECT_{—}1 can be stored at FILTERED_FRAME_{—}1.

A different between FILTERED_FRAME_{—}0 and a current image from INPUT_OBJECT_{—}0 is calculated and the resulting information stored at DIFFERENCE_FRAME_{—}0 line 405. Similarly, a different between FILTERED_FRAME_{—}1 and a current image from INPUT_OBJECT_{—}1 is calculated and the resulting information stored at DIFFERENCE_FRAME_{—}1 at line 406. Finally, DIFFERENCE_FRAME_DIFFERENCE_FRAME_{—}1, and a current state (e.g., value or group of values of) of MOVEMENT_OBJECT are provided to the DISPLACEMENT( ) function, and the results are stored at MOVEMENT_OBJECT,

In some implementations, MOVEMENT_OBJECT is an output object and outputs its state. For example, the current state of MOVEMENT_OBJECT can be output to a communications link, data store, storage service, messaging service, display, or other device in addition to being provided to the DISPLACEMENT( ) function.

Referring to FIG. 3, the compilation system can parse description of application 400 and identify INPUT_OBJECT_{—}0, INPUT_OBJECT_{—}1, FILTERED_FRAME_{—}0, FILTERED_FRAME_{—}1, DIFFERENCE_{—}0, DIFFERENCE_FRAME_{—}1, and MOVEMENT_OBJECT as objects based on definitions of those objects (not shown) or the use of those objects (e.g., assignment of results of operations to those objects) within description of application 400 at block 310. As an example of definition of an object, a class definition or a structure definition can be a definition of an object. That is, the compilation system can determine based on definitions of objects or the use of objects (e.g., use of objects as operands to operations such as functions) that some variable name in a description of an application represents an object. Moreover, the compilation system can determine properties of a data structure (e.g., an arrangement of variables and/or objects) associated with an object based on a definition or the use of the object.

After the objects within a description of an application are identified, state paths among the objects of the application are determined at block 320. In other words, the compilation system identifies how states of objects flow among the objects described in the description of the application. Said differently, the compilation system analyzes the description of the application to determine operations through which objects interact.

Referring to description of application 400 illustrated in FIG. 4 as an example, the compilation system can determine state paths among operands of operations and the objects on which those operations are performed. More specifically, the compilation system can identify at line 403 that INPUT_OBJECT_{—}0 is an argument to the function FILTER( ) (i.e., that INPUT_OBJECT_{—}0 is an operand of an operation defined by the function FILTER( ) and the result of the function FILTER( ) is stored at FILTERED_FRAME_{—}0 (i.e., that the operation is performed on FILTERED_FRAME_{—}0 because the result of the operation modifies FILTERED_FRAME_{—}1). Accordingly, the compilation system can determine that a state path exists between INPUT_OBJECT_{—}0 and FILTERED_FRAME_{—}0. Similarly, the compilation system can determine that a state path exists between INPUT_OBJECT_{—}1 and FILTERED_FRAME_{—}1 based on line 404.

Additionally, the compilation system can identify at line 405 that FILTERED_FRAME_{—}1) and INPUT_OBJECT_{—}0 are operands of a difference operation and that operation is performed on DIFFERENCE_FRAME_{—}0 (i.e., that the result of the difference operation is stored at DIFFERENCE_FRAME_{—}0), and thus determine that a state path exists between FILTERED_FRAME_{—}0 and DIFFERENCE_FRAME_{—}0 and between INPUT_OBJECT_{—}0 and DIFFERENCE_FRAME_{—}0. In other words, the state of DIFFERENCE_FRAME_{—}0 depends on the state of FILTERED_FRAME_{—}0, the state of INPUT_OBJECT_{—}0, and the difference operation. Similarly, the compilation system can identify at line 406 that FILTERED_FRAME_I and INPUT_OBJECT_{—}1 are operands of a difference operation and that operation is performed on DIFFERENCE_FRAME_{—}1 and thus determine that a state path exists between FILTERED_FRAME_{—}1 and DIFFERENCE_FRAME_{—}1 and between INPUT_OBJECT1 and DIFFERENCE_FRAME_{—}1. That is, the state of DIFFERENCE_FRAME_{—}1 depends on the state of FILTERED_FRAME_{—}1, the state of INPUT_OBJECT_{—}1, and the difference operation.

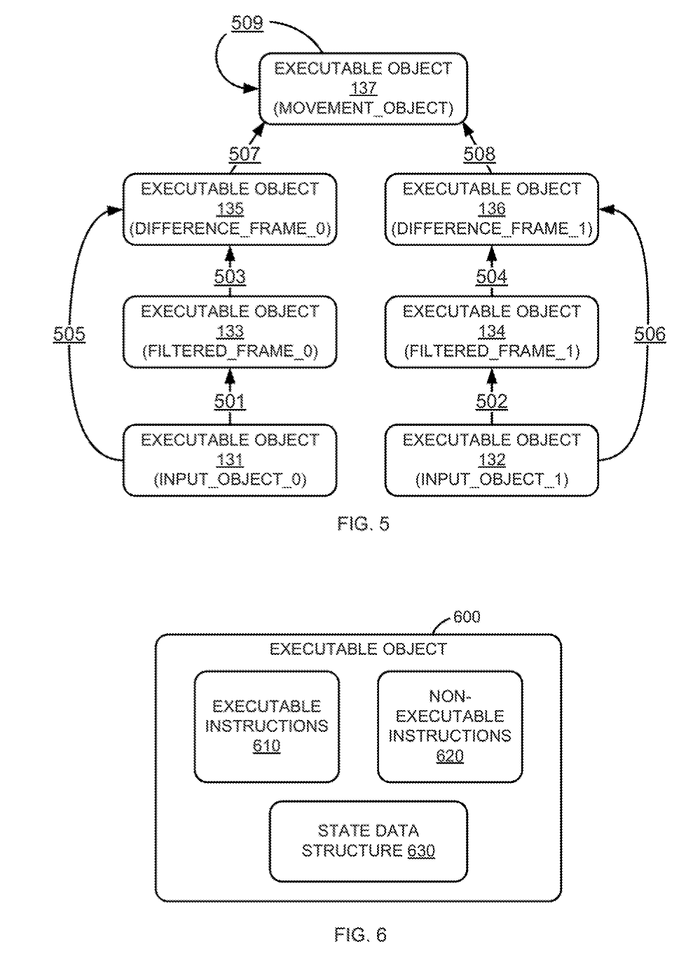

In some implementations, the compilation system implementing process 300 can represent state paths among objects as a graph of executable objects corresponding to those objects in which the edges of the graph represent state paths. FIG. 5 is an illustration of a graph of executable objects and state paths among the executable objects, according to an implementation. As discussed herein a graph is a data structure or a group of data structures that expresses relationships among information.

Graph 500 is a graphical illustration of a graph that includes nodes 131 137 and edges 501 509. Nodes 131 137 represent executable objects corresponding to objects INPUT_OBJECT0, INPUT_OBJECT_{—}1, FILTERED_FRAME_0, FILTERED_FRAME_{—}1, DIFFERENCE_FRAME_0, DIFFERENCE_FRAME_{—}1, and MOVEMENT_OBJECT. An executable object can be said to correspond to an object if that executable object has a state (or a data structure according to which a state is stored at a memory) that is substantially the same as a state of that object. In some implementations, an executable object that corresponds to an object performs an operation (when executing at a host) that is described within a description of an application as performed on that object. Edges 501 509 represent state paths among the objects to which objects INPUT_OBJECT_{—}0, INPUT_OBJECT_{—}1, FILTERED_FRAME_{—}0, FILTERED_FRAME_{—}1, DIFFERENCE_FRAME_{—}0, DIFFERENCE_FRAME_{—}1, and MOVEMENT_OBJECT correspond, and along which states, are transferred among the executable objects representing those objects.

More specifically, edge 501 represents the state path between INPUT_OBJECT_{—}0 (represented by node 131) and FILTERED_FRAME_{—}0 (represented by node 133); edge 503 represents the state path between FILTERED_FRAME_{—}0 (represented by node 133) and DIFFERENCE_FRAME_{—}0 (represented by node 135); edge 505 represents the state path between INPUT_OBJECT_{—}0 (represented by node 131) and DIFFERENCE_FRAME_{—}0 (represented by node 135); edge 507 represents the state path between DIFFERENCE_FRAME_{—}0 (represented by node 135) and MOVEMENT_OBJECT (represented by node 137); edge 502 represents the state path between INPUT_OBJECT_{—}1 (represented by node 132) and FILTERED_FRAME_{—}1 (represented by node 134); edge 504 represents the state path between FILTERED_FRAME_{—}1 (represented by node 134) and DIFFERENCE_FRAME_{—}1 (represented by node 136); edge 506 represents the state path between INPUT_OBJECT_{—}1 (represented by node 132) and DIFFERENCE_FRAME_{—}1 (represented by node 136); edge 508 represents the state path between DIFFERENCE_FRAME_{—}1 (represented by node 136) and MOVEMENT_OBJECT (represented by node 137); and edge 509 represents the state path between MOVEMENT_OBJECT (represented by node 137) and itself.

Accordingly, as an example, referring to block 320 illustrated in FIG. 3, the compilation system implementing process 300 can generate a graph based on operations described in the description of the application to determine state paths among objects. Process 300 then proceeds to block 330 at which executable objects are generated. In the example illustrated in FIG. 3, executable objects are generated by generating or outputting instructions corresponding to operations in the description of the application and other instructions that do not correspond to those operations. More specifically, instructions corresponding to operations in the description of the application are generated at block 331, instructions related to a synchronization mechanism not included in the description of the application are generated at block 332, and instructions to exchange state according to the state paths determined at block 320 are generated at block 333. Blocks 331, 332, and 333 are performed to generate instructions for each executable object used to implement the application described by the description of the application.

As a specific example, at block 331, instructions that implement an operation performed, as described in the description of the application, on an object to which each executable object corresponds are generated and included in that executable object. Additionally, instructions that cause each executable object to store its state at a memory according to a data structure of the object to which that executable object corresponds are generated and included in the executable object.

Instructions related to a synchronization mechanism can be generated according to a variety of synchronization methodologies at block 332. As discussed above, a synchronization mechanism causes the executable objects to perform operations synchronously, and is not described or included in the description of the application. As an example, the compilation system (e.g., an instruction module of the compilation system) can generate an additional executable object that operates as a synchronization mechanism to provide synchronization signals (e.g., messages) to the other executable objects. The executable objects can include instructions to exchange messages (e.g., send and receive) one with another via, for example, shared memory (e.g., shared memory within a computing system or GPU) of a host or network communications. In some implementations, the synchronization mechanism can provide synchronization signals to the executable objects at regular intervals. Thus, the executable objects can execute synchronously with respect to the synchronization signals.

In other implementations, the compilation system can include instructions at each executable object to cause that executable object to provide a complete signal for message) to the synchronization mechanism after that executable object completes an operation described in the description of the application and for which instructions are included within that executable object. That is, the compilation system includes instructions in each executable object to cause each executable object to perform an operation derived from the description of the application, provide a complete signal (e.g., a message indicating that that executable object has completed an operation) to the synchronization mechanism, and to wait (e.g., not perform the operation another time) for a signal from the synchronization mechanism. After the synchronization mechanism receives a complete signal from each executable object, the synchronization mechanism provides a synchronization signal to each executable object. Such synchronization signals can be referred to as lockstep signals because they cause the executable object to perform in lockstep with respect to the operations performed at the executable objects. In other words, the executable objects each perform an operation (defined by instructions at that executable object) simultaneously, and synchronize before performing the operation again.

In response to the synchronization signal, each executable object provides its state to other executable objects according to state paths, and receives state from other executable objects according to state paths. After providing and receiving any state according to state paths, each executable object again performs its operation, this time using any received state. In some implementations, the executable objects synchronize again after providing and receiving state according to state paths. For example, the executable objects can again send complete signals, and the synchronization mechanism (i.e., the executable object implementing the synchronization mechanism) can send a synchronization signal after receiving a complete signal from each executable object. The executable objects then each perform their respective operations in response to the synchronization signal, provide a complete signal, and wait again for a synchronization signal.

As another example of a synchronization mechanism, each executable object can provide a complete signal to each other executable object when that executable object completes an operation. That is, each executable object includes instructions to provide a synchronization signal such as a complete signal to the other executable objects that collectively implement an application. As in the example discussed above, after performing the operation and providing the complete signal, each executable object waits. However, in this example, each executable object waits for a complete signal from each other executable object rather than for a synchronization signal. After an executable object receives a complete signal from each other executable object, that executable object provides its state to other executable objects. Thus, the synchronization mechanism is internal to each executable object (i.e., based on instructions included within the executable object that were generated at the compilation system).

Similarly as discussed above, executable objects can also wait on the synchronization mechanism to perform their operations after exchanging state according to state paths. That is, after exchanging state according to state paths the executable objects can provide complete signals to all the other executable objects, and proceed to perform their respective operations after receiving complete signals from each other executable object. In yet other implementations, an executable object can proceed to perform its respective operation after receiving state along each state path via which another executable object or other executable objects provide state to that executable object. In other words, after state of any executable objects that provide state to an executable object is received at that executable object, that executable object can proceed to perform its operation.

Furthermore, in some implementations, such synchronization mechanisms can be combined. Thus, for example, each executable object waits for a synchronization mechanism by waiting to receive complete signals from each other executable object of an application and to receive a synchronization signal. In some implementations, the synchronization signal can be a complete signal. Thus, each executable object is responsive to a synchronization mechanism by waiting for a number of complete signals that is equal to the number of executable objects (i.e., the number of other executable objects plus one additional complete signal) that implement an application. For example, each executable object includes instructions not included within the description of the application that cause that executable object to wait for a complete signal from each other executable object that collectively implement an application and one additional complete signal from, for example, a debugger.

The compilation system implementing process 300 also generates instructions to cause the executable objects that implement an application to exchange state according to state paths at block 333. In other words, the compilation system includes instructions that cause the executable objects to exchange state one with another within a computing environment hosting the executable objects (or application). For example, the compilation system can generate instructions that cause the executable objects to provide state via shared memory and/or network communications to other executable objects based on the state paths determined at block 320.

As an example, the compilation system can generate instructions that include or make accessible identifiers of executable objects to which an executable object should provide its current state, and instructions that cause the executable object to provide its current state to those executable objects. More specifically, for example, the compilation system can generate instructions for each executable object that cause the executable objects to access a directory that maps an identifier of each executable object to a host at which that executable is executing. Each executable object can include an identifier of executable objects to which that executable object should provide state, and can access the directory to identify the host at which those executable objects are executing. That executable object can then provide state to those hosts to provide the state to the executable objects executing at those hosts.

As an example of an executable object, FIG. 6 is an illustration of an executable object generated at a compilation system, according to an implementation. Executable object 600 includes executable instructions 610, non-executable instructions 620, and state data structure 630. In some implementations, executable object does not include state data structure 630 separate from executable instructions 610 and non-executable instructions 620. Rather, executable instructions 610 and non-executable instructions 620 define memory accesses that cause executable object 600 to access (e.g., read and write) state at a data structure based on an object in a description of an application.

Executable instructions 610 are codes and/or values that are executable at a host of executable object 600. For example, executable instructions 610 can include Java™ bytecodes, machine code such as x86 machine code, binary codes, or other codes that can be executed at a host. Non-executable instructions 620 are instructions that require further processing before executing at a host. For example, non-executable instructions 620 can include OpenCL instructions that are compiled for a particular host just prior to executing on the host (or just in time) and/or Java™ instructions that are compiled just in time. Thus, the instructions that define an executable object can include various types of classes of instructions provided by compilation system.

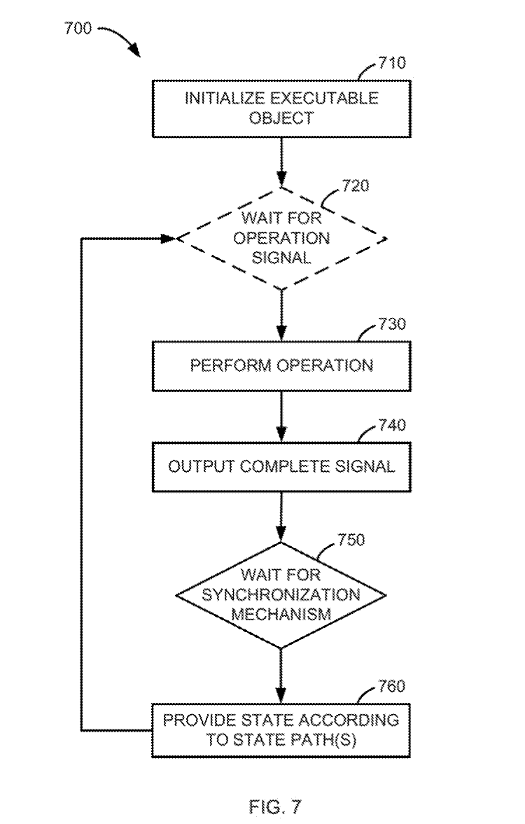

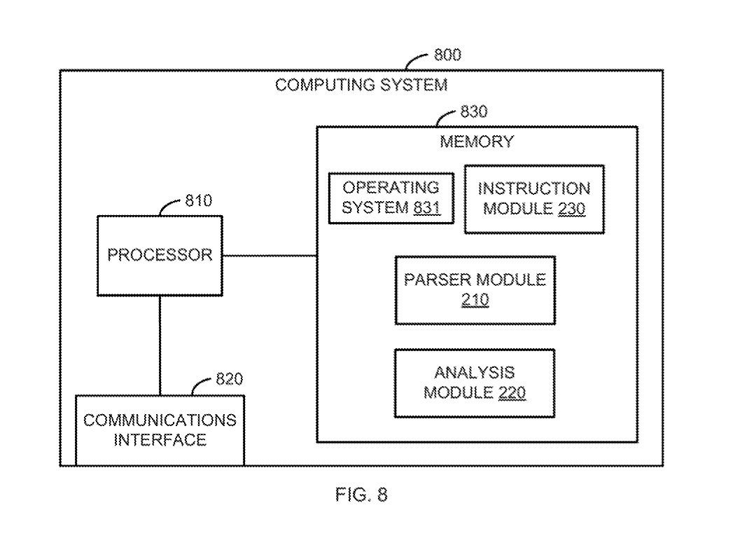

As an example of execution of an executable object, FIG. 7 is a flowchart of a process implemented by an executable object, according to an implementation. As discussed above, an executable object executes at a host. That is, the instructions of the executable object are executed at a host At block 710, the executable object is initialized. An executable object is initialized by preparing a host to execute the executable object. For example, non-executable instructions of the executable object can be compiled or otherwise prepared for execution and variables or data structures associated with the executable object can then be assigned initial values. Moreover, in some implementations, the executable object can access a directory to identify the hosts at which executable objects to which the executable object should provide state are executing.

In some implementations, the executable object then waits at block 720 for an operation signal. The operation signal indicates that the executable object should perform an operation defined by the instructions of the executable object. The operation signal can be a synchronization signal such as a complete signal. Moreover, in some implementations and as discussed above in relation to complete signals, the executable object can wait for multiple operation signals (e.g., operation signals from multiple executable objects to indicate that those executable objects have completed an initialization procedure). Accordingly, in some implementations, block 710 can include providing an operation signal to indicate that an executable object is ready to perform an operation.

Process 700 then proceeds to block 730 at which the operation of the executable object is performed. That is, the host at which the executable object is hosted executes instructions to perform an operation that is described in a description of an application from which this executable object and other executable objects that implement the application were partially derived. Said differently, the executable object performs an operation of the application at block 730. As discussed above, the operation can be non-atomic at the host for the executable object, and can include multiple calculations, steps, or sub-operations.

After the operation is performed at block 730, a complete signal is output (or sent) at block 740 to indicate that the executable object has completed its operation. As discussed above, the complete signal can be output to an executable object implementing a synchronization mechanism that provides synchronization signals, and/or to other executable objects that implement an application. The executable object then waits at block 750 on the synchronization mechanism. That is, the executable object waits for an indication from a synchronization mechanism (e.g., a synchronization signal or a number of complete signals) that the executable object should proceed to provide state according to state paths.

Process 700 then proceeds to block 760 at which state is exchanged among the executable objects according to state paths. After the state is exchanged according to state paths, process 700 returns to block 730 at which the operation of the executable object is performed. As illustrated in FIG. 7, in some implementations, process 700 waits at block 720 for an operation signal before performing the operation again at block 730.

As an illustrative example, process 700 can be discussed in connection with graph 500 illustrated in FIG. 5. As discussed above, nodes 131-137 represent executable objects corresponding to objects in description of description of application 400 illustrated in FIG. 4, and edges 501-509 represent state paths the present discussion, nodes 131-137 will also be referred to as executable objects 131-137.

When the application implemented by executable objects 131 -137 illustrated in FIG. 5 (i.e., the application defined by description of application 400) is hosted within a computing environment (such as a distributed computing environment in which each executable object is hosted at a computing system or a computing system with one or more GPUs in which each executable object is hosted at the one or more GPUs), each of executable objects independently implements process 700. Thus, each executable object can execute its respective operation simultaneously with the other executable objects. Referring to description of application 400, the operation of executable object 131 is to access an current image of CAMERA_{—}0; the operation of executable object 132 is to access an current image of CAMERA_{—}1; the operation of executable object 133 is to apply the operation of the FILTER( ) function to an image received from executable object 131; the operation of executable object 134 is to apply the operation of the FILTER( ) function to an image received from executable object 132; the operation of executable object 135 is to determine the difference between state received from executable objects 131 and 133; the operation of executable object 136 is to determine the difference between state received from executable objects 132 and 134; and the operation of executable object 137 is to perform the DISPLACEMENT( ) function to state received from executable objects 135 and 136 and prior state of executable object 137.

After each of the executable objects is initialized, each executable object performs its respective operation and then waits on the synchronization mechanism. In response to the synchronization mechanism, each executable object provides its state (e.g., the results of its operation) according to the state paths from that executable object. More specifically, executable object 131 provides its state to executable objects 133 and 135; executable object 132 provides its state to executable objects 134 and 136; executable object 133 provides its state to executable object 135: executable object 134 provides its state to executable object 136; executable object 135 provides its state to executable object 137; executable object 136 provides its state to executable object 137; and executable object 137 provides its state to itself (e.g., uses its current state to define its next state). Each executable object then (as discussed above in some implementations again in response to the synchronization mechanism) performs its operation again using the state or states received. This process continues as the states of executable objects propagate through the application (or executable objects) in lockstep, making execution of the application deterministic, repeatable, and debuggable.

FIG. 8 is a schematic block diagram of a compilation system hosted at a computing system, according to an implementation. In the example illustrated in FIG. 8, computing system 800 includes processor 810, communications interface 820, and memory 830. Processor 810 is any combination of hardware and software that executes or interprets instructions, codes, or signals. For example, processor 810 can be a microprocessor, an application-specific integrated circuit (ASIC), a distributed processor such as a duster or network of processors or computing systems, a multi-core or multi-processor processor, or a virtual or logical processor of a virtual machine.

Communications interface 820 is a module via which processor 810 can communicate with other processors or computing systems via communications link. A communications link includes devices, services, or combinations thereof that define communications paths between devices or services (not shown). For example, a communications link can include one or more of a cable (e.g., twisted-pair cable, coaxial cable, or fiber optic cable), a wireless link (e.g., radio-frequency link, optical link, or sonic link), or any other connectors or systems that transmit or support transmission of signals. Moreover, a communications link can include communications networks such as an intranet, the inter, et, other telecommunications networks, or a combination thereof. Additionally, a communications link can include proxies, routers, switches, gateways, bridges, load balancers, and similar communications devices.

As a specific example, communications interface 820 can include a network interface card and a communications protocol stack hosted at processor 810 (e.g., instructions or code stored at memory 830 and executed or interpreted at processor 810 to implement a network protocol) to receive and send action requests. As specific examples, communications interface 820 can be a wired interface, a wireless interface, an Ethernet interface, a Fiber Channel interface, an InfiniBand interface, and IEEE 802.11 interface, or some other communications interface via which processor 810 can exchange signals or symbols representing data to communicate with other processors or computing systems.

Memory 830 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 830 can be a volatile random access memory (RAM), a persistent data store such as a hard disk drive or a solid-state drive, a compact disc (CD), a digital video disc (DVD), a Secure Digital™ (SD) card, a MultiMediaCard (MMC) card, a CompactFlash™ (CF) card, or a combination thereof or other memories. Said differently, memory 830 can represent multiple processor-readable media. In some implementations, memory 830 can be integrated with processor 810, separate from processor 810, or external to computing system 800.

Memory 830 includes instructions or codes that when executed at processor 810 implement operating system 831 and a compilation system including parser module 210, analysis module 220, and instruction module 230. Parser module 210, analysis module 220, and instruction module 230 can collectively be referred to as a compilation system. As discussed above, a compilation system can include additional or fewer modules (or components) than illustrated in FIG. 8.

In some implementations, computing system 800 can be a virtualized computing system. For example, computing system 800 can be hosted as a virtual machine at a computing server. Moreover, in some implementations, computing system 800 can be a virtualized computing appliance, and operating system 831 is a minimal or just-enough operating system to support (e.g., provide services such as a communications protocol stack and access to components of computing system 800 such as communications interface 820) parser module 210, analysis module 220, and instruction module 230.

The compilation system including parser module 210, analysis module 220, and instruction module 230 can be accessed or installed at computing system 800 from a variety of memories or processor-readable media. For example, computing system 800 can access a compilation system at a remote processor-readable medium via communications interface 820. As a specific example, computing system 810 can be a network-boot device that accesses operating system 831, parser module 210, analysis module 220, and instruction module 230 during a boot sequence.

As another example, computing system 800 can include (not illustrated in FIG. 8) a processor-readable medium access device (e.g., CD, DVD, SD, MMC, or a CF drive or reader), and can access parser module 210, analysis module 220, and instruction module 230 at a processor-readable medium via that processor-readable medium access device. As a more specific example, the processor-readable medium access device can be a DVD drive at which a DVD including an installation package for one or more of parser module 210, analysis module 220, and instruction module 230 is accessible. The installation package can be executed or interpreted at processor 800 to install one or more of parser module 210, analysis module 220, and instruction module 230 at computing system 800 (e.g., at memory 830). Computing system 800 can then host or execute one or more of parser module 210, analysis module 220, and instruction module 230.

In some implementations, parser module 210, analysis module 220, and instruction module 230 can be accessed at or installed from multiple sources, locations, or resources. For example, some of parser module 210, analysis module 220, and instruction module 230 can be installed via a communications link (e.g., from a file server accessible via a communication link), and others of parser module 210, analysis module 220, and instruction module 230 can be installed from a DVD.

In other implementations, parser module 210, analysis module 220, and instruction module 230 can be distributed across multiple computing systems. That is, some of parser module 210, analysis module 220, and instruction module 230 can be hosted at one computing system and others of parser module 210, analysis module 220, and instruction module 230 can be hosted at another computing system. As a specific example, parser module 210, analysis module 220, and instruction module 230 can be hosted within a cluster of computing systems where each of parser module 210, analysis module 220, and instruction module 230 is hosted at multiple computing systems, and no single computing system hosts each of parser module 210, analysis module 220, and instruction module 230.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e. processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanism (e.g., sending data to a computing system or agent via a communications path or channel), pull mechanisms (e.g., delivering data to a computing system or agent in response to a request from the computing system or agent), and store mechanisms (e.g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

What is claimed is:

1. A processor-readable medium storing code representing instructions that when executed at a processor cause the processor to:
identify a plurality of objects within a description of an application;
determine a plurality of state paths among the plurality of objects, each state path from the plurality of state paths derived from an operation included in the description of the application on an object from the plurality of objects for which another object from the plurality of objects is an operand; and
generate a plurality of executable objects, each executable object independently executable and associated with a data structure representing a state of that executable object,
each executable object including in ructions that when executed at a host for that executable object cause the host for that executable object
to perform an operation associated with that executable object and
to provide the state of that executable object to one or more other executable objects from the plurality of executable objects according to one or mere state paths from the plurality of state paths in response to a synchronization mechanism not defined within the description of the application.

2. The processor-readable medium of claim 1, wherein the operation associated with each executable object corresponds to an operation included in the description of the application on an object uniquely corresponding to that executable object.

3. The processor-readable medium of claim 1, wherein the synchronization mechanism is a synchronization signal not defined within the description of the application.

4. The processor-readable medium of claim 1, wherein the instructions included at each executable object when executed at the host for that executable object, cause the host for that executable object to perform the operation associated with that executable object during a first time period and to provide the state of that executable object with one or more other executable objects from the plurality of executable objects during a second time period, the synchronization mechanism separating the first time period from the second time period.

5. The processor-readable medium of claim 1, wherein the instructions included at each executable object when executed at the host for that executable object cause the host for that executable object to output a complete signal after the operation associated with that executable object is performed.

6. The processor-readable medium of claim 1, wherein
the instructions included at each executable object when executed at the host for that executable object cause the host for that executable object to output a complete signal after the operation associated with that executable object is performed; and
the synchronization mechanism includes is based on the complete signal output after the operation associated with each executable object is performed.

7. A compilation system, comprising:
a parser to identify a plurality of objects within a description of an application;
an analysis module to analyze a plurality of operations associated with objects from the plurality of objects and to determine a plurality of state paths among the plurality of objects based on the plurality of operations; and
an instruction module to generate a plurality of independent executable objects, each executable object including instructions that when executed at a host for that executable object cause the host for that executable object
to perform an operation associated with that executable object,
to provide a state of that executable object to one or more other executable objects from the plurality of executable objects according to one or more state paths from the plurality of state paths in response to a synchronization mechanism not defined within the description of the application, and
based on instructions not defined within the description of the application, to not perform the operation associated with that executable object again until after the state of that executable object is provided to one or more other executable objects.

8. The system of claim 7, wherein each state path from the plurality of state paths is defined between an object from the plurality of objects operated on by an operation from the plurality of operations and another object from the plurality of operations that is an operand of the operation.

9. The system of claim 7, wherein the analysis module determines, for each object from the plurality of objects, at least one state path from the plurality of state paths between that object and at least one other object from the plurality of objects that is an operand of an operation on that object.

10. The system of claim 7, wherein the synchronization mechanism is a synchronization signal not defined within the description of the application.

11. The system of claim 7, wherein the instructions included at each executable object when executed at the host for that executable object cause the host for that executable object to output a complete signal after the operation associated with that executable object is performed.

12. A processor-readable medium storing code representing instructions that when executed at a processor cause the processor to:
identify a plurality of objects within a description of an application;
identify, for each object from the plurality of objects within the description of the application, an operation on that object for which at least one other object from the plurality of objects is an operand;
define, for each object from the plurality of objects, at least one state path between that object and each of the at least one other object from the plurality of objects that is an operand of the operation on that object; and
generate a plurality of executable objects, each executable object uniquely corresponding to an object from the plurality of objects,
each executable object associated with a data structure representing a state of that executable object and
including instructions that when executed host for that executable object cause the host for that executable object
to perform on that exec able object the operation on the object uniquely corresponding to that executable object and
to provide the state of that executable object to one or more other executable objects from the plurality of executable objects according to the at least one state path for the object uniquely corresponding to that executable object in response to a synchronization mechanism not defined within the description of the application.

13. The processor-readable medium of claim 12, wherein the synchronization mechanism is a synchronization signal not defined within the description of the application.

14. The processor-readable medium of claim 12, wherein the instructions included at each executable object when executed at the host for that executable object cause the host for that executable object to output a complete signal after the operation on that executable object is performed.

15. The processor-readable medium of claim 12, wherein the instructions included at each executable object when executed at the host for that executable object cause the host for that executable object to perform the operation associated with that executable object during a first time period and to provide the state of that executable object with one or more other executable objects from the plurality of executable objects during a second time period, the synchronization mechanism separating the first time period from the second time period.
